(19) United States
(12) Patent Application Publication
(10) Pub. No.: US 2013/0189429 A1
(43) Pub. Date: Jul. 25, 2013

(54) Method for Producing a Locally Limited Diffusion Coat and Reactor for it

(71) Applicant: Heinrich Walter, Friedberg (DE)

(72) Inventor: Heinrich Walter, Friedberg (DE)

(73) Assignee: MTU Aero Engines GmbH, Munich (DE)

(21) Appl. No.: 13/560,808

(22) Filed: Jul. 27, 2012

(30) Foreign Application Priority Data
Jul. 28, 2011 (DE) 10 2011 108 771.4

(51) Int. Cl. B05C 21/00

(52) U.S. Cl. CPC B05C 21/005
USPC 427/180; 427/256; 118/58

(57) ABSTRACT

A method for producing a locally limited diffusion coat on a metallic component is disclosed. In an embodiment, the method includes arranging the component and at least one dispenser pack containing the material to be diffused, making available at least one protective gas stream, which flows around the at least one region of the component that is not to be provided with a diffusion coat, and heating the component and the dispenser pack to a temperature for carrying out the diffusion and maintaining the temperature for a specific time. A reactor for producing a locally limited diffusion coat on a metallic component is also disclosed.

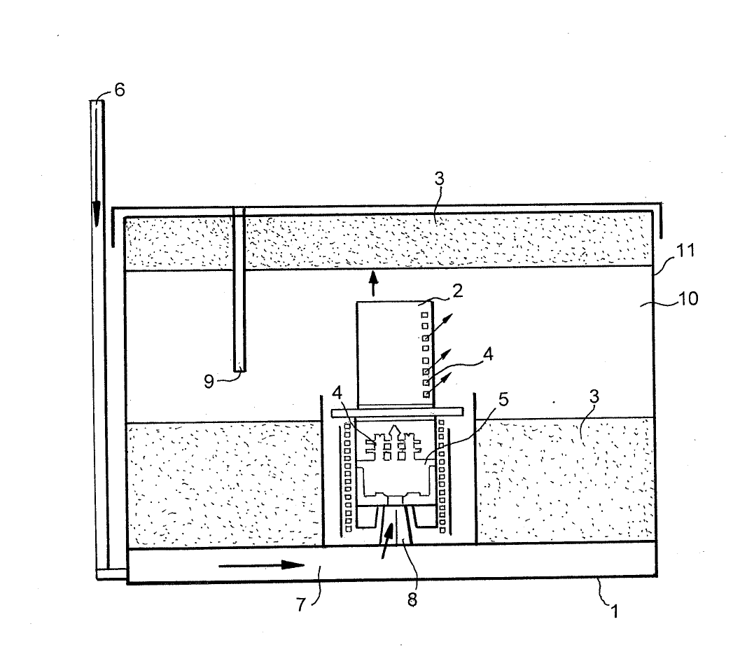

This application claims the priority of German Patent Document No. DE 10 2011 108 771.4, filed Jul. 28, 2011, the disclosure of which is expressly incorporated by reference herein.

### BACKGROUND AND SUMMARY OF THE INVENTION

The present invention relates to a method for producing a locally limited diffusion coat on a metallic component and a corresponding reactor for it.

Diffusion coats in which metals such as aluminum, silicon or chromium are diffused in the surface regions of a metallic component such as, for example, a turbine blade, are known for forming protective layers. In addition, it is known that the problem that arises when aluminizing, siliconizing and chromium plating is that component sections that are not supposed to be provided with a corresponding diffusion coat can only be protected with difficulty from the undesired formation of a diffusion coat. Proposals for protecting the component surface from forming diffusion coats are described, for example, in German Patent Document Nos. DE 43 44 061 C1 and DE 103 47 363 A1.

DE 43 44 061 C1 proposes providing the component with two coats in the regions in which no aluminizing or chromium plating is supposed to take place, namely with a first layer that is designed as a separating layer and a second layer that is designed as a getter layer for reaction gases. The first layer may form a slip-casting layer of oxide ceramic particles with a low-carbon and halide-free binder, and the second layer may be a metal layer or a metallic slip-casting layer.

DE 103 47 363 A1 provides that a diffusion-blocking powder pack be provided on the regions of the component that are not to be coated.

Although both methods may be used successfully to protect components against undesired diffusion coats, there are limitations in that not all components or component regions are able to be protected equally well. Particularly in the case of turbine blades in which inner cooling channels or cavities are not supposed to be provided with a diffusion coat, there is the problem that protective arrangements, e.g., in the form of a powder pack, are not able to be arranged in a suitable manner and/or subsequently are only able to be removed at considerable expense or not at all.

Therefore, the object of the present invention is making available a method for producing a locally limited diffusion coat on a metallic component, as well as a corresponding reactor, that is able to reliably prevent regions of a component that are not to be provided with a diffusion coat from forming a diffusion coat, and wherein this method is simple to execute or a corresponding reactor is simple to operate. In particular, the expense for removing protective arrangements is kept low.

The invention starts from the knowledge that component regions that are not supposed to be provided with a diffusion coat may be protected by a protective gas stream if an adequate quantity of protective gas or an adequate flow of a protective gas is made available at a suitable protective gas stream pressure. This is possible, for example, by using a nozzle device to form a directed protective gas stream, which can be directed in a targeted manner onto the regions of the components that are not to be provided with the diffusion coat so that the transport processes required to form the diffusion coat may be interrupted there via halogen compounds. Alternatively, a covering may also be provided on the component that forms a cavity or channel between the component surface and the covering so that the corresponding protective gas stream may be guided through this cavity or the channel in order to achieve a better concentration of the protective gas stream with a high protective gas pressure or a strong protective gas flow on the to-be-protected component surface.

Furthermore, one is also able to make use of the geometry of the component and use cavities or channels that are not supposed to be provided with a diffusion coat in order to concentrate the protective gas stream or the protective gas.

To introduce the protective gas into the cavity of the component or a channel of the component in a defined manner, the reactor may be provided with an appropriate adapter, which has a connection both to the cavities or channels of the component and to a protective gas supply line of the reactor.

The present invention may be used in conjunction with various diffusion coats, e.g., to form aluminum-rich layers or aluminized layers, PtAl, CrAl, MCrAlY layers or combinations thereof. Siliconized and/or chromium-plated coats are also conceivable.

Moreover, the present invention may be used both in producing diffusion coats in which a powder pack is used as the dispenser pack to make the material to be diffused available and in corresponding methods in which the coating material is applied directly on the surface of the substrate—for example, in the form of a paste by spraying, painting, immersion and the like.

The protective gas for protecting regions that are not to be provided with a diffusion coat may be the same protective gas that is used in a corresponding reactor to form an inert or reducing atmosphere. In particular, inert gases such as noble gases, e.g., argon, or hydrogen and combinations thereof, are possible, wherein hydrogen is advantageous due to its reducing effect for preventing oxides.

In particular, the present invention may be used in the aluminizing of turbine blades with inner cooling channels, in which an aluminizing of the cooling channels is supposed to be prevented.

In this case, the protective gas is introduced into cooling channels during the production process of the diffusion coat by an adapter in order to protect the cooling channels from the aluminizing.

### BRIEF DESCRIPTION OF THE DRAWING

The FIGURE shows a purely schematic representation of a sectional view through a reactor according to the invention with the to-be-processed component, the dispenser packs and the protective gas line.

### DETAILED DESCRIPTION OF THE DRAWING

Additional advantages, characteristics and features of the present invention will be made clear by the following detailed description of an exemplary embodiment. However, the invention is not limited to this exemplary embodiment.

The FIGURE shows an exemplary embodiment of a reactor 1 according to the invention, which is suitable for carrying out the method according to the invention. The reactor 1 has a reactor interior space 10, which is limited by a reactor vessel 11. The component 2 to be provided with the diffusion coat, which is a turbine blade 2 in the present case, is arranged in the reactor interior space 10. Arranged around the turbine blade 2 are several dispenser packs 3 in the form of powder packs, which contain a metal powder or a powder of a metal-rich compound for making available the metal to be diffused. The powder packs 3 furthermore have a neutral filling material, e.g., an oxide such as aluminum oxide, which prevents an agglomeration of the fine metal powder. In addition, the powder pack 3 contains a so-called activator, for example a halogen compound such as AlCl3 or AlF3, which serves as a chemical transport agent for the metal to be diffused. In addition, the reactor has a heating apparatus (not shown in more detail), which enables it to heat up the reactor interior space 10—and therefore the turbine blade 2 and the powder packs 3—to a temperature at which the diffusion processes are able to take place to form a diffusion coat.

The reactor vessel 11 has a double bottom 7, which is attached to a gas supply line 6 so that protective gas, e.g., noble gases like argon and/or other protective gases such as hydrogen, is able to be introduced into the reactor vessel 11 via the double bottom 7. Arranged in the double reactor bottom 7 is an outlet 8 to which an adapter 5 is attached, which in-turn is connected to cooling channels and cavities 4 of the turbine blade 2 so that protective gas, which is introduced via the protective gas supply line 6 and the double bottom 7, may be introduced via the adapter 5 into the cooling channels and other cavities 4 of the turbine blade 2 that are not supposed to be provided with the diffusion coat. The excess protective gas, which has passed through the cooling channels and cavities 4 of the turbine blade 2, is output into the reactor interior space 10 via the cooling channel openings, which are arranged at the end of the cooling channels 4 that are opposite from the end with the adapter 5. The flow of the protective gas is depicted by the arrows in the FIGURE.

The formation of a diffusion coat is reliably prevented because of an adequate quantity of protective gas that flows through the cooling channels and cavities 4 of the turbine blade.

After completion of the diffusion coat, the heater is turned off so that the turbine blade 2 cools and the inflow of protective gas is stopped. The turbine blade 2 that was provided with a partial diffusion coat is able to be removed without further cleaning measures such as, for example, removing covering powder or the like. As a result, it is possible to forgo expensive processes for removing covering agents, something that substantially increases the efficiency of the method.

Although the present invention has been described in detail on the basis of the exemplary embodiment, it is self-evident to a person skilled in the art that the invention is not limited to this exemplary embodiment, but that in fact modifications are possible by omitting individual features or by a different combination of the features presented without leaving the scope of protection of the enclosed claims. In particular, the present invention includes the combination of all individual features presented.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for producing a diffusion coat on a component, comprising the steps of:
flowing a gas stream to a region of the component;
forming a diffusion coat on the component; and
preventing the forming of the diffusion coat in the region of the component by the gas stream.

2. The method according to claim 1, wherein the diffusion coat includes aluminum and/or silicon and/or chromium.

3. The method according to claim 1, wherein the diffusion coat is provided from a powder pack or a paste.

4. The method according to claim 3, wherein the component and the powder pack or the paste are disposed in a reactor.

5. The method according to claim 1, further comprising the steps of:
covering the region of the component with a cover to form a channel between the cover and the region; and
flowing the gas stream through the channel.

6. The method according to claim 1, wherein the region of the component is a cavity and/or a channel.

7. The method according to claim 1, wherein the component is a turbine blade.

8. A reactor for producing a diffusion coat on a component, comprising:
a reactor chamber;
a diffusion coating pack disposed within the reactor chamber; and
a protective gas, wherein the protective gas is supplyable to a region of a component disposed in the reactor chamber.

9. The reactor according to claim 8, wherein the reactor has a double bottom and wherein the protective gas is flowable through the double bottom.

10. The reactor according to claim 9, further comprising an outlet arranged in the double bottom and wherein the protective gas is flowable through the outlet.

11. The reactor according to claim 10, further comprising an adapter coupled to the outlet, wherein the protective gas is flowable through the adapter to the region of the component.
